(19) United States
(12) Patent Application Publication
(10) Pub. No.: US 2015/0197976 A1
(43) Pub. Date: Jul. 16, 2015

(54) Double-pivot synchronization mechanism for opening and closing two leaves

(71) Applicant: Paul TALBOT, St-Hubert (CA)

(72) Inventor: Paul Talbot, St-Hubert (CA)

(21) Appl. No.: 14/419,081

(22) PCT Filed: Mar. 12, 2014
(86) PCT No.: PCT/IB2014/059691

§ 371 Date: Feb. 2, 2015

Related U.S. Application Data
(60) Provisional application No. 61/779,112, filed on Mar. 13, 2013.
(60) Provisional application No. 61/779,151, filed on Mar. 13, 2013.

(51) Int. Cl. E05F 17/00; F16H 21/44

(52) U.S. Cl. CPC E05F 17/004; F16H 21/44; E05F 2017/008

(57) ABSTRACT

The double-pivot synchronization is characterized in that each leaf is connected to an opening arm by an opening pivot. The other end of the opening arm is connected to a second pivot. This second pivot adds a degree of freedom to the components that are connected to it and thereby, frees them from the constraints imposed by the rotation of the leaves on the hinges. These components can thus be synchronized more easily. The mechanism comprises an arrangement of rigid elements, connected between them and attached to the frame.

A first embodiment has a rail and is particularly suitable for manufacturers of furniture and cabinets who use custom-made components. A second embodiment, with rail, is better suited to a shallow frame and simplifies the adjustment to the width of the leaves. A robust and versatile third embodiment has gear teeth and mainly targets walk-through doors and recessed synchronization mechanisms.

### TECHNICAL FIELD

Mechanism to synchronize the opening and closing of two leaves or two pivoting parts configured with a central opening.

### BACKGROUND INFORMATION

Dual synchronized closing doors are not widespread because of the complexity, bulk and high cost of synchronization mechanisms. They are usually equipped with two motorized and communicating actuators (e.g. EP2551434A2, EP2551435A2). The same drawbacks apply to non-motorized synchronization systems, which are based either on the principle of the pivoting rudder (e.g. FR2568929B3, EP0819815A1) or on that of the transmission shaft (e.g. CN202325037U). The pivoting rudder only offers a limited opening angle and requires the addition of two tie rods at the ends of the door leaves, which implies a broader framework and a specific installation. Regarding the transmission shaft, it requires bevel gears at both ends which fit into those of two vertical pivots. A variant of the application DE3546242A1 includes an opening arm with two pivots, but the mechanism requires an arrangement of chains, strings, connecting rods, spindles, pins and a cross-like articulation, hidden under the floor. These mechanisms are heavy, expensive and poorly compatible with hinges to be located inside or outside the doors.

So being, existing synchronization mechanisms are restricted to specific applications, such as telephone booths, gates, transports and public places. Yet, it is well known that a central opening door reduces clutter while opening, when compared to a single-leaf door with the same opening.

This mechanism aims to make it more accessible synchronizing double leaves or two pivoting parts configured with a central opening. According to my research, it does not exist to date, any simple and lightweight mechanism for the mechanical synchronization of double leaves, be it those of a walk-through door, a cabinet door, the door of a piece of furniture, of a vehicle, of a household appliance such as a refrigerator or the two leaves of a casement window.

### BRIEF SUMMARY

The double-pivot synchronization is characterized in that each leaf (2 or 3) is connected to the end of an opening arm (6) by an opening pivot (5). The other end of the opening arm (6) is connected to a second pivot (8 or 12). This second pivot adds a degree of freedom to the components that are connected to it and thereby, frees them from the constraints imposed by the rotation of the leaves on the hinges (4). These components can thus be synchronized more easily.

The mechanism comprises an arrangement of rigid elements, connected between them and attached to the frame. Said arrangement is configured such that all elements can be located on the frame side, allowing both leaves to close completely along a line linking their axis of rotation. The mechanism can thus be hidden beneath the frame, if desired. The movement of each mobile element occurs in a plane orthogonal to the axis of rotation of the leaves, limiting the thickness of the mechanism.

### DETAILED DESCRIPTION

Here are three non-limitative embodiments of the double-pivot synchronization mechanism:

A first non-limitative embodiment (FIG. 1) is characterized in that the other end of each opening arm (6) is attached to a rear pivot (8), attached to a carriage (7) that moves along a cross rail (9), itself fixed to the frame (1). The distance between the opening pivots (6) and the rear pivot (8) can be fixed or variable:
by telescoping two sections to adjust the length of the opening arms (6);
or by drilling multiple holes at the end of each opening arm (6) and by selecting one of these holes to insert the rear pivot (8).

The distance between the opening pivots (6) and outer ends of the leaves constitutes a second parameter. The combination of these two adjustments gives room to adapt the mechanism to different leaves' widths and to control the maximum opening angle. This embodiment is economical and particularly suitable for manufacturers of furniture and cabinets that use custom-made components.

A second non-limitative embodiment (FIG. 2), sharing all the components of the first one, is characterized in that:
the other end of each opening arm (6) is attached, using a mobile pivot (12), to one end of a forearm (10) whose other end is attached to a front pivot (13), itself attached to the frame;
two rear arms (11) connect intermediate positions on the forearms (10), using mobile pivots (12), to a rear pivot (8), attached to a carriage (7) that moves along a cross rail (9), itself fixed to the frame (1).

As the path of the carriage (7) is reduced, this embodiment is more adapted to a shallow frame (1) and makes it easier to adjust to the width of the leaves. It mainly targets the synchronization of existing double-door cabinets or furniture units.

For common applications (FIG. 5), the carriage (7) is made of a rigid, self-lubricating material such as high-density polyethylene (HD-PE). It has grooves (16) on both sides and can slide freely inside the rail (9), which has a compatible shape. A hole is drilled in the carriage (7) so as to be screwed with a bolt whose widened neck acts as a rear pivot (8). For particular applications (FIG. 6), the carriage (7) is provided with wheels (17) or other rolling mechanism, such as recirculating bearings, to roll inside or outside the rail (9).

A third non-limitative embodiment (FIG. 3), sharing many components of the second one, is characterized in that:
the other end of each opening arm (6) is connected, using a mobile pivot (12), to one end of a forearm (10);
The other ends of the forearms (10) are rounded, toothed (14), juxtaposed and attached to the frame (1), by two front pivots (13) so that their gear teeth mesh together, said front pivots (13) being centered relative to the circular arcs formed by the toothed ends (14).

To make the installation easier, the front pivots (13) and the toothed ends (14) can be pre-installed in a gear housing (15) whose both sides are opened to allow the forearms (10) to pivot freely. For safety reasons, the toothed ends (14) must be covered either by a gear housing (15) or by other means. This third embodiment is robust and versatile. It allows, among other things, to replace the single leaf of a walk-through door with two narrower leaves. By adjusting the dimension and the shape of components, the mechanism can be hidden under the lintel. This embodiment is also suitable for recessed synchronization mechanisms, as in vehicles or household appliances.

### OTHER FEATURES AND BENEFITS

Compared to a single-leaf door with the same opening, this mechanism reduces the frequency and severity of injuries associated with a sudden opening of the door from a person on the other side. The width of the door leaves (2 and 3) and their opening speed are halved and the central opening allows two individuals to see each other quickly to prevent an accident.

The space required for the opening of the door being reduced, new architectures or arrangements are possible. The two leaves (2 and 3) can be of different width.

This mechanism allows the use of conventional hinges (4), either located inside or outside the door. If necessary, hinges (4) can be gotten around by the opening arms (6), by curving them outward. If self-closing is required, tension should be lessened to reduce torsion and traction force. This can be achieved by removing self-closing from some hinges or by other means.

When required, the right leaf (2) is distinguished from the left leaf (3). Inner edges of the leaves then have an oblique rabbet (FIG. 4) allowing the covering leaf (2) to block the covered one (3) along its entire height, while reducing the risk of jamming during closure. Indeed, the edge of the covering leaf (2) can slide slightly over that of the covered leaf (3). A lock comprising a top latch can be installed on the covering leaf (2). The lock may also comprise a bottom latch and one or more horizontal points for the covered leaf (4).

When the synchronization mechanism is recessed, as in the case of the door of a refrigerator, it can be installed either at the leaves' top, bottom or both. To reduce the size of a vertical door, leaves can be arranged horizontally, as in the case of an oven door. The mechanism can then be installed at the left of the leaves, at the right or on both sides.

For common use, the total thickness of the mechanism is about one or two centimeters. To maximize clearance on both sides, some arms can be crank-shaped. This mechanism can thus be used to synchronize the two leaves of a cabinet door, of a piece of furniture, a vehicle, a household appliance or a window.

The synchronization of double leaves meets a practical need. Often, both leaves of the double door of a cabinet must be opened to access the desired object, which requires two hands to perform these operations simultaneously. To put inside an object of significant size, a single hand is available, since one hand is already being used to hold this object. Conversely, to remove the object from the cabinet, only one hand is left to close the two leaves. The time savings resulting from the synchronization of the leaves may seem small, but while accumulating over the lifetime of a frequently used door, the results are significant. The risk of dropping an object by attempting to open or close a door leaf with a hand full is also reduced.

The synchronization of the rear-door leaves of a vehicle, allows for opening, locking in the open position and closing the door by manipulating a single leaf. For an emergency vehicle such as an ambulance, the time saved can be invaluable.

### BEST MODE FOR CARRYING OUT THIS MECHANISM

The first embodiment is economical and particularly suitable for manufacturers of furniture and cabinets that use custom-made components. The second embodiment mainly targets the synchronization of existing double doors of cabinets or furniture units. The third embodiment is robust and versatile; it can replace the single leaf of a walk-through door by two narrower leaves. By adjusting the dimension and the shape of components, the mechanism can be hidden under the lintel. This third embodiment is also suitable for recessed synchronization mechanisms, as in vehicles or household appliances.

### INDUSTRIAL APPLICABILITY

This mechanism can be used to synchronize the two leaves of:
a cabinet door or that of a piece of furniture;
a walk-through door or a window;
the door of an appliance;
the door of a vehicle or that of a trailer;
a gate, a container, a cover or a lid;
a locker, a cupboard, a closet or a safe.

### BRIEF DESCRIPTION OF THE DRAWINGS

FIG. 1 is a plan view of the assembly of the first embodiment, as installed within a cabinet.

FIG. 2 is a plan view of the assembly of the second embodiment, as installed within a cabinet.

FIG. 3 is a plan view of the assembly of the third embodiment, as installed within a cabinet.

FIG. 4 is a close-up, plan view of the edge of the leaves: covering (2) and covered (3).

FIG. 5 is a sectional view of the rail (9), of a sliding carriage (7) with grooves (16) and the rear pivot (8). To clarify the illustration, the opening arms (6) and rear arms (11) are not shown.

FIG. 6 is a plan view of the rail (9), of a rolling carriage (7) with wheels (17) and the rear pivot (8). To clarify the illustration, the opening arms (6) and rear arms (11) are not shown.

1. Synchronization mechanism for the opening and closing of two leaves (2 and 3) comprising:
Two hinges (4) or more, or any other mechanism to rotate these leaves around two equivalent vertical axis;
Two opening pivots (5), fixed to the top of the leaves (2 and 3), near the ends fitted with hinges (4), on the frame side (1);
Two opening arms (6), whose one end is connected to an opening pivot (5) and the other end to a second pivot (8 or 12);
Characterized in that the transversal synchronization (front-rear) of components is achieved by the transversal movement of the second pivot (8 or 12), while the symmetric inversion (left-right) relies on the rotation of the components around said second pivot.

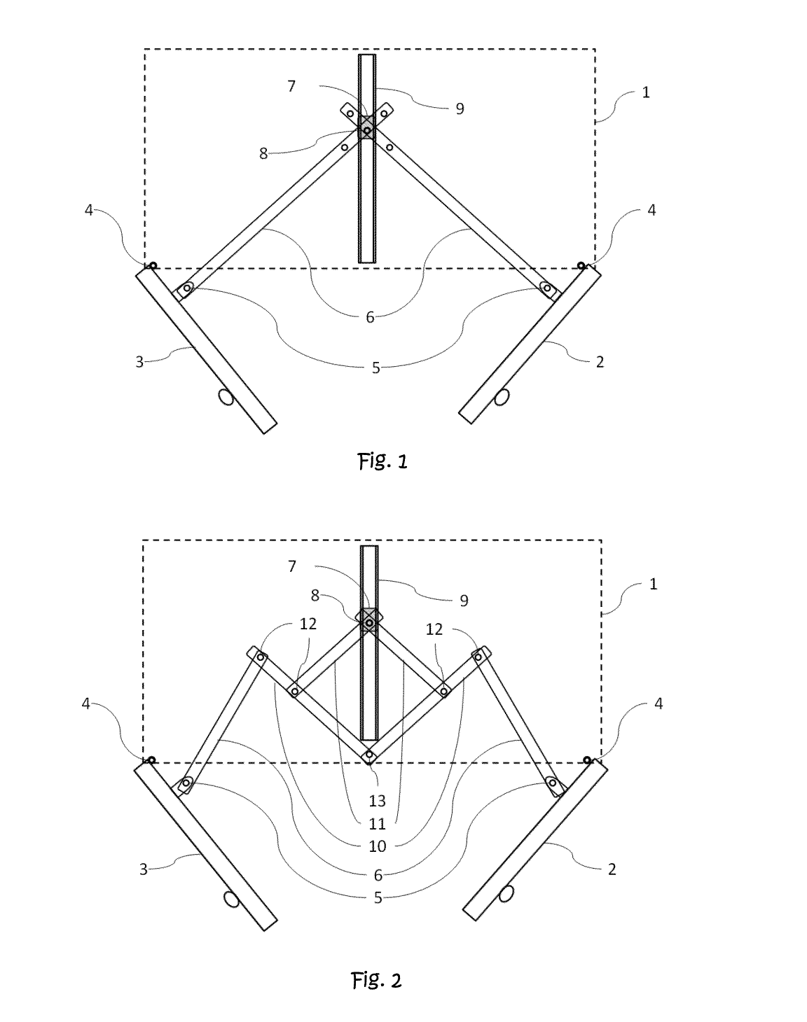

2. Synchronization mechanism (FIG. 1) according to claim 1, characterized in that the ends of opening arms (6) are connected to a rear pivot (8), fixed under the carriage (7) that moves along a central cross rail (9), fixed beneath the top of the frame (1).

3. Synchronization mechanism (FIG. 2) according to claim 1, characterized in that:
The ends of the opening arms (6) are connected, using mobile pivots (12), to one end of the forearms (10) whose other end is connected to a front pivot (13), itself secured to the frame at the front end of the rail (9);
Two rear arms (11) connect intermediate positions on the forearms (10), using mobile pivots (12), to a rear pivot (8), fixed under the carriage (7) that moves along a central cross rail (9), fixed beneath the top of the frame (1).

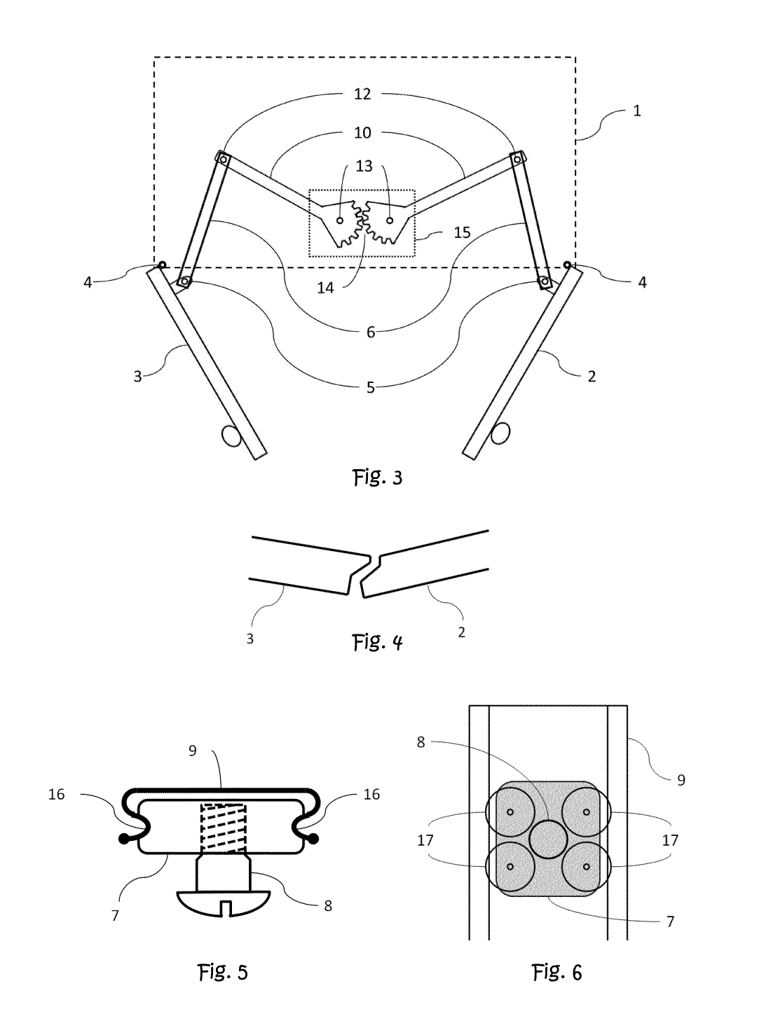

4. Synchronization mechanism (FIG. 3) according to claim 1, characterized in that:
The ends of the opening arms (6) are connected, using mobile pivots (12), to one end of the forearms (10);
The other ends of the forearms (10) are rounded, toothed (14), juxtaposed and centered under the top of the frame (1) by two front pivots (13), so that their gear teeth mesh together, said front pivots (13) being centered relative to the circular arcs formed by the toothed ends (14).

5. Synchronization mechanism according to any of claim 2 or 3 (FIG. 5), characterized in that the carriage (7) is made from a rigid and self-lubricating material, said carriage (7) being grooved (16) on both sides to slide freely along the rail (9), which has a compatible shape; a vertical hole being drilled in the center of said carriage (7) so as to be screwed with a bolt whose widened neck acts as a rear pivot (8).

6. Synchronization mechanism according to any of claim 2 or 3 (FIG. 6), characterized in that the carriage (7) has four horizontal wheels (17) rolling inside or outside the rail (9).

7. Synchronization mechanism according to claim 4 (FIG. 3), characterized in that the front pivots (13) and the toothed ends (14) are pre-installed in a gear housing (15), whose both sides are opened to allow the front arms (10) to pivot freely.

8. Synchronization mechanism according to any previous claim, characterized in that the opening arms (6) are curved outward, so as to get around the hinges (4).

9. Synchronization mechanism according to any previous claim, characterized in that the central edges of the leaves have an oblique rabbet (FIG. 4), allowing the covering leaf (2) to stop the covered one (3) along its entire height, while reducing the risk of jamming during closure.

10. Synchronization mechanism according to any previous claim, characterized in that it is located at the bottom, at the left or at the right of the two leaves (2 and 3).

11. A door, a window, a cabinet, a piece of furniture, a vehicle, a household appliance, a trapdoor, a locker, a box or a closet, characterized in that it is fitted with two leaves synchronized by a mechanism according to any previous claim.
